(19) United States
(12) Patent Application Publication
(10) Pub. No.: US 2014/0259829 A1
(43) Pub. Date: Sep. 18, 2014

(54) LIGHTING SYSTEM FOR NIGHTTIME SCENE MANAGEMENT

(71) Applicant: John Nagy, Springfield, OR (US)

(72) Inventor: John Nagy, Springfield, OR (US)

(21) Appl. No.: 14/213,468

(22) Filed: Mar. 14, 2014

Related U.S. Application Data
(60) Provisional application No. 61/792,448, filed on Mar. 15, 2013.

(51) Int. Cl. G09F 13/02

(52) U.S. Cl. CPC G09F 13/02
USPC 40/559

(57) ABSTRACT

A collapsible lighting system for nighttime or low-light scene management has a collapsible frame moveable from a first collapsed configuration to a second, non-collapsed configuration and at least one light support member coupled to the collapsible frame for supporting one or more lights that can be angled at least generally downward from the light support member when the collapsible frame is in the non-collapsed.

### CROSS REFERENCE TO RELATED APPLICATION

This application claims the benefit of U.S. Provisional Application No. 61/792,448 filed Mar. 15, 2013, which is herein incorporated by reference in its entirety.

### FIELD

The present disclosure is directed to novel lighting systems and methods of use and, in particular, to nighttime scene management systems and methods.

### BACKGROUND

During a traffic emergency in low light or dark conditions, it is essential to establish traffic control on both ends of the emergency scene. Typically traffic will need controlled for the entire duration from first responders initial arrival until the scene is cleared and traffic can flow unobstructed by the accident and emergency response apparatus. Many safety devices are at the ready for first responders that aid in keeping them safe while setting up and controlling traffic during a traffic emergency. Some of these would include stop/slow signs, high visibility garments such as vests and jackets, reflective striping on garments and helmets, colored light sticks or flares, traffic cones, flashing lights on the person, on the ground near the scene or on the stop/slow sign, etc.

However, conventional systems are often insufficient and it remains a significant safety concern that first responders and others cannot be seen by vehicles approaching an emergency scene, even with the safety devices previously mentioned. One such difficulty is that while on an emergency scene, all of the emergency apparatus will have their emergency lights on to warn drivers approaching the emergency scene from a long distance away and as a vehicle approaches close proximity of an emergency scene, and these lights on the emergency apparatus can be distracting to a driver and often “camouflage” a person performing traffic control duties.

### SUMMARY

In one embodiment, a collapsible lighting system for nighttime or low-light scene management is provided. The system can include a collapsible frame, the collapsible frame being moveable from a first collapsed configuration to a second, non-collapsed configuration; at least one light support member coupled to the collapsible frame; one or more lights coupled to the at least one light support member, the lights being configured to be angled at least generally downward from the light support member when the collapsible frame is in the non-collapsed configuration; and at least one traffic control indicator couple to the collapsible frame.

In another embodiment, a method of deploying a lighting system is provided. The method can include deploying a collapsible frame from a first collapsed configuration to a second, non-collapsed configuration, the collapsible frame comprising at least one traffic control indicator couple to the collapsible frame; deploying at least one light support member coupled to the collapsible frame from a collapsed configuration to a second non-collapsed configuration; and positioning one or more lights coupled to the at least one light support member so that the lights are angled at least generally downward from the light support member.

The foregoing and other objects, features, and advantages of the invention will become more apparent from the following detailed description, which proceeds with reference to the accompanying figures.

### BRIEF DESCRIPTION OF THE DRAWINGS

FIG. 1A illustrates a lighting system for illuminating traffic control, safety personnel, and others in low-light conditions, shown in a maximum deployment arrangement.

FIG. 1B illustrates a lighting system for illuminating traffic control, safety personnel, and others in low-light conditions, shown in a minimum deployment arrangement.

FIG. 2A illustrates a top view of the system shown in FIG. 1A.

FIG. 2B illustrates a top view of the system shown in FIG. 1B.

FIG. 3A illustrates another embodiment of a lighting system for illuminating traffic control, safety personnel, and others in low-light conditions, when in a first deployed configuration.

FIG. 3B illustrates system shown in FIG. 3A in a different configuration.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

The novel systems and methods described herein provide for improved visibility of persons involved in nighttime or other low light scenes, such as first responders, traffic controllers, safety personnel, etc. These systems and methods improve visibility by providing bright white light(s) that illuminates the person performing the traffic control function and the area directly around them from above. This arrangement significantly improves visibility and helps set such persons apart from other lights or distractions—such as the backdrop of flashing red, blue and amber lights from the emergency apparatus on scene.

The lighting systems are desirably configured so that one person (e.g., an emergency first responder) can utilize a stop/slow traffic control device that has a light attached atop the device, allowing him or her—as well as any associated traffic control device such as a stop sign—to be seen by vehicle traffic approaching the scene. These systems can be all in one type systems, and can be designed so that it can be stowed in a convenient sized package and can be deployed quickly. This device can be carried, deployed and used by one person. Exemplary lighting systems are illustrated in FIGS. 1, 2, and 4. The number of lights and the arrangement of those lights can vary within the scope of this invention. For example, as shown in FIG. 3, the system can include a configuration with four lights, in contrast to the two-light system illustrated in FIG. 1 and the three-light system illustrated in FIG. 2.

Conventional portable lights do not provide any integrated control structures (e.g., stop/slow signs) that are needed to complete a safety package for traffic control and other nighttime or low-light scene managers. The portable, lighted traffic control device disclosed herein provides a one unit that performs all functions needed to mitigate the issue of not being seen on an emergency traffic scene. The light and sign go with the person performing traffic control wherever they go. This device used with the other safety items marketed for emergency traffic control can make a significant improvement on traffic control safety for emergency first responders.

### EXAMPLE 1

This device and have tested it in dark conditions where it has performed as designed; it lights up the person using the device and illuminates the area around them distinguishing them as traffic control from other activities going on behind them. My initial attempt used a spot type light rather than a flood type light which turned out to not perform as well as desired. After changing the light style to a flood and trying different heights above the sign, it has performed to my expected results. Using dual 18 watt, 12 VDC LED lights, mounted 180 degrees from each other has proved to perform to expected results.

The prototype that has been built utilizes:

2@ Truckstar 1492115 6 lamp LED flood lights, approximately 10 feet of 1″ schedule 40 PVC piping, 1@ 12VDC 9ah rechargeable gel cell battery SLAA12-9F2, 1@ 2 pole electrical switch, approximately 12 feet of 2 conductor 16 awg. Cable and 1@18″ reflective stop/slow paddle.

### ALTERNATIVE LIGHTING ARRANGEMENT

An amber or red strobe can be provided on top of the light bar mount. A perimeter lighted stop/slow paddle could be used in conjunction with the overhead light. A two/way radio mount can be mounted to the device stand below the stop/slow sign.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

I therefore claim as my invention all that comes within the scope and spirit of these claims.

1. A collapsible lighting system for nighttime or low-light scene management, the system comprising:
a collapsible frame, the collapsible frame being moveable from a first collapsed configuration to a second, non-collapsed configuration;
at least one light support member coupled to the collapsible frame;
one or more lights coupled to the at least one light support member, the lights being configured to be angled at least generally downward from the light support member when the collapsible frame is in the non-collapsed configuration; and
at least one traffic control indicator couple to the collapsible frame.

2. The lighting system of claim 1, wherein the traffic control indicator is positioned beneath the at least one light support member.

3. The lighting system of claim 2, wherein the traffic control indicator comprises at least one of a stop sign or a slow sign.

4. The lighting system of claim 1, further comprising a battery power source for powering the one or more lights coupled to the lighting system.

5. The lighting system of claim 1, wherein the collapsible frame comprise a collapsible tri-leg structure at its base.

6. The lighting system of claim 1, wherein the one more lights comprise at least two lights.

7. The lighting system of claim 1, wherein the one more lights comprise at least three lights.

8. The lighting system of claim 1, wherein the at least one light support member comprises a collapsible system so that the at least one light support member is moveable between a deployed configuration where the one or more lights extend horizontally outward from the collapsible frame and a retracted configuration where the one or more lights are positioned closer to the collapsible frame.

9. The lighting system of claim 1, further comprising a top mounted strobe light, the strobe light being positioned above the one or more lights.

10. The lighting system of claim 1, wherein the traffic control indicator is a stop sign.

11. The lighting system of claim 1, wherein the traffic control indicator is a slow sign.

12. A method of deploying a lighting system comprising:
deploying a collapsible frame from a first collapsed configuration to a second, non-collapsed configuration, the collapsible frame comprising at least one traffic control indicator couple to the collapsible frame;
deploying at least one light support member coupled to the collapsible frame from a collapsed configuration to a second non-collapsed configuration; and
positioning one or more lights coupled to the at least one light support member so that the lights are angled at least generally downward from the light support member.

13. The method of claim 12, wherein the deployment of the collapsible from comprises telescoping one portion of the collapsible frame from another portion of the collapsible frame.

14. The method of claim 12, wherein the deployment of the collapsible from comprises extending a hinged portion of the collapsible frame from another portion of the collapsible frame.

15. The method of claim 12, further comprising deploying a collapsible tri-leg stand to stabilize the collapsible frame, the collapsible tri-leg stand being coupled to a lower portion of the collapsible frame.

16. The method of claim 12, further comprising turning on a strobe light coupled to the collapsible frame at a top portion.

17. The method of claim 12, wherein the act of deploying the at least one light support member comprises extending a first hinged portion of the light support member outwardly from the collapsible frame.

18. The method of claim 12, further comprising turning on the one or more lights to illuminate safety personnel working in the vicinity of the collapsible frame.

19. The method of claim 12, wherein the traffic control indicator comprises an instruction to slow or stop.
